(19) United States
(12) Patent Application Publication
(10) Pub. No.: US 2010/0142741 A1
(43) Pub. Date: Jun. 10, 2010

(54) Loudspeaker

(76) Inventor: Jan Princeton Plummer, Marietta, GA (US)

Correspondence Address: KEVIN J. MCNEELY, ESQ., 5335 WISCONSON AVENUE, NW, SUITE 440, WASHINGTON, DC, 20015, US

(21) Appl. No.: 12/614,651

(22) Filed: Nov. 9, 2009

Related U.S. Application Data
(63) Continuation-in-part of application No. 11/760,788, filed on Jun. 10, 2007, now Pat. No. 7,614,479.
Application No. 11/760,788 is a continuation-in-part of application No. 11/683,845, filed on Mar. 8, 2007, now abandoned.
Application No. 11/683,845 is a continuation of application No. 10/709,538, filed on May 12, 2004, now Pat. No. 7,207,413.

(51) Int. Cl. H04R 1/02; H04R 9/06

(52) U.S. Cl. 381/345; 381/398

(57) ABSTRACT

A speaker with an embedded sound enhancement module includes a magnet, a pole piece positioned within the magnet, a sleeve surrounding the pole piece, a conductive wire coil wound around the sleeve between the magnet and the pole piece, a dust cap or diaphragm attached to a circumference of the sleeve, a speaker cone surrounding the dust cap, and an enclosed chamber having an aperture to access an internal volume of the chamber and an alternative density transmission medium (ADTM) positioned within a portion of the internal volume.

### CROSS-REFERENCE TO RELATED APPLICATIONS

This utility patent application is a continuation-in-part of U.S. patent application Ser. No. 11/760,788 filed Jun. 10, 2007 and Ser. No. 11/683,845 filed on Mar. 8, 2007, which is a continuation of U.S. Pat. No. 7,207,413 issued on Apr. 24, 2007, which are incorporated by reference herein.

### BACKGROUND OF THE INVENTION

A typical loudspeaker is an electric voice coil attached to a diaphragm of some depth, diameter and shape. Electro-dynamic describes a transducer that moves back and forth in response to an alternating voltage source to stimulate adjacent air molecules. Some of these types of loudspeakers may be considered a commodity and are inexpensive. They are typically mounted on a baffle as part of an existing product or structure; in some form of housing for practical containment or in some cases a specialized enclosure is utilized to enhance the bass performance.

One problem with these types of loudspeakers is that the driver may have a favorable acoustic impedance only over a narrow range of frequencies depending on its size. The smaller driver generally has unfavorable acoustical impedance for lower frequencies and vise versa for larger ones. The enclosure also favors a narrow range of frequencies and for other frequencies it may react violently creating a plethora of incoherent internal standing waves that modulate the diaphragm with nonsymmetrical vibration patterns. These random internal modulations disturb the natural dispersion pattern of the driver and cause electrical feedback (reactance) to the amplifying source. Brute force power and heavy gauge wiring are amongst current attempts to minimize this problem for the amplifier and the effects on sound quality.

Another problem is the general acoustic impedance differential that exists on either side of the driver diaphragm. The diaphragm must work simultaneously in two different acoustic environments as the enclosure creates standing waves that constantly modify the drivers' acoustic impedance in most of its frequency range. Reflected waves from the room cause additional modifications of the drivers' acoustic impedance more as the frequencies go lower towards that of the rooms' dimensions. Smaller enclosures can be worse because of the even higher frequencies that are reflected internally and the lack of low frequency capabilities.

Two identical drivers will sound different due to their operating enclosure. One solution with mid-range speakers is to produce units with a solid basket behind the diaphragm. This may prevent random standing waves from interfering with the other drivers but it may create extreme backpressure for the range of frequencies produced by the midrange driver. This causes the driver to see a distinct acoustic impedance differential throughout its operating range thereby preventing it from producing a natural sound.

Loudspeaker driver dimensions favor a certain range of frequencies thus making a single size for all frequencies difficult if wide axis listening is desired. It is a design goal to produce loudspeakers of the smallest dimensions necessary at minimum cost while maintaining the proper loudness level while retaining the sonic presentation of full frequency range, low distortion and wide-constant dispersion. A solution is the use of multiple drivers operating for a common acoustic purpose. This is reflected in current loudspeaker designs in an effort to produce subjectively accepted loudspeakers.

When a single driver is used, it is typically designed to favor the middle frequency ranges (voice) while attempting to maintain acoustic output in the lower and high frequency range. For loudspeakers smaller or larger drivers are typically added to extend the bass and treble. For earphones or headphones the bass frequencies are typically increased by the close (and sealed) location relative to the eardrum while higher frequencies are obtained by design.

The human ear tends to more sensitive to the middle frequencies but the human ear-brain combination prefers to hear all of the frequencies in the spectrum without phase or frequency aberrations to interrupt the flow of energy of the event otherwise it will appear to be artificial. The reproduction of sound is typically for either of two purposes and that is communication and entertainment. The latter requires unencumbered sonic balance and dispersion to balance the energy in the listening environment.

The continued efforts to perfect sound reproduction with predictable field results depend greatly on a solution to solve the dilemma of the enclosure. Engineers recognize the drivers' enclosure as a design challenge. The use of the apparatus as explained in the pending application can improve sound quality.

### SUMMARY

The application of the device improves the reproduction of audio frequencies. In particular, the proposed invention relates to loudspeakers and in particular methods of improving the quality of reproduction for very low, low, middle and higher frequencies, reducing the relative enclosure dimensions, reducing the costs and dependency on the acoustics of a particular physical location for consistent results.

In one general aspect, a sound enhancement module includes a set of walls that define an enclosed chamber, an aperture in one of the walls to provide a path for audio waves to travel between the enclosed chamber and an external space and an alternative density transmission medium positioned in the enclosed chamber.

Embodiments may include one or more of the following features. For example, a disc may be positioned near the aperture. The disc may be made of metal and it may have a circular opening that is positioned coaxial to the aperture. A shelf may surround the aperture and the disc may be positioned in the shelf with an outer surface of the disc flush with an outer surface one of the module walls.

The module walls may include a set of six walls configured as a rectangular box. The walls may be made of a composite wood material.

As another feature, the enclosed chamber may have a cylindrical shape. The alternative density transmission medium in the chamber may be open cell foam.

In still another general aspect, a sound enhancement module includes walls defining an enclosed chamber, an aperture in one of the walls to provide a path for audio waves to travel between the enclosed chamber and an external space, a shelf surrounding the aperture, a disc positioned on the shelf such that a circular opening of the disc is coaxially positioned relative to the aperture and an alternative density transmission medium positioned in the enclosed chamber.

Embodiments may include one or more of the above or following features. For example, the module may have a front wall and a back wall. The front wall includes the shelf, the aperture and the enclosed chamber and the back wall is a rectangular panel that attaches to the front wall. In another embodiment, the enclosed chamber, shelf and aperture are first, second and third circular bores in the front wall.

In still another general aspect, a method of improving the sound quality from a speaker system with a sound enhancement module with features described above includes retrofitting the speaker system with the sound enhancement module.

Embodiments may include one or more of the following operations. For example, retrofitting may include removing a wall of a speaker cabinet, fixing the sound enhancement module to the inside of the speaker cabinet and reattaching the wall of the speaker cabinet. The center of the aperture may be positioned along a central axis of a speaker in the speaker cabinet. As another example, the sound enhancement module may be positioned behind a speaker attached to a front wall of the speaker cabinet. As still a further feature, the sound enhancement module may be fixed to a rear wall of the speaker cabinet.

In another general aspect, a speaker with an embedded sound enhancement module includes a magnet, a pole piece positioned within the magnet, a sleeve surrounding the pole piece, a conductive wire coil wound around the sleeve between the magnet and the pole piece, a dust cap or diaphragm attached to a circumference of the sleeve, a speaker cone surrounding the dust cap, and an enclosed chamber having an aperture to access an internal volume of the chamber and an alternative density transmission medium (ADTM) positioned within a portion of the internal volume.

Embodiments may include one or more of the following features. For example, the chamber may be positioned at a first end of the pole piece proximate to the dust cap or at a second end of the pole piece distal to the dust cap.

An air passage connects the internal volume of the chamber to the volume behind the dust cap when the chamber is not adjacent to the dust cap. The air passage may be a passageway through the pole piece.

The chamber may be configured as a cavity inside the magnet or the pole piece. The aperture may be an opening in a surface of the magnet or the surface of the pole piece.

The chamber may include a first internal surface and the alternative density transmission medium can be mounted to the first internal surface. A surface area (X) of the first internal surface may be X=√A₁, wherein A₁ comprises the speaker cone area. In another embodiment, the surface area (X) of the first internal surface includes a range from X=·0.7A₁ to X=√1.2A₁.

The aperture size (Φ₀) may be r₁/π, wherein r₁ comprises a speaker cone radius (rᵢ).

The chamber may include a first internal surface and a second internal surface and the alternative density transmission medium can be mounted to the first internal surface. The distance between the first internal surface and the second internal surface includes the thickness (t) of the alternative density transmission and a length of an air gap (T). The thickness of the alternative density transmission medium may be t=√r₁, wherein rᵢ comprises a speaker cone radius and the length of the air gap may be T=√Φ₁, wherein Φ₁ comprises a diameter of the speaker cone.

The alternative density medium may be a compressible foam material or a closed cell foam.

In certain embodiments, the chamber is centered along a radial axis of the pole piece, magnet, speaker cone or dust cap.

### BRIEF DESCRIPTION OF THE DRAWINGS

FIGS. 1A and 1B are side and front cross section views of a speaker enclosure in accordance with one of the embodiments of the invention.

FIG. 2 is a cross section view of a conventional speaker enclosure.

FIG. 3 is a cross section view of a speaker enclosure according to one of the embodiments of the invention.

FIGS. 4A and 4B are cross section front and side views of the speaker enclosure with a reflex port added.

FIG. 5 is a cross section view of the Direct Coupled (DC) embedded acoustic transmission line (EATL) in accordance with one of the embodiments of the invention.

FIG. 6 is a cross section view of the DC EATL physically combined with a standard non-damped bass reflex enclosure.

FIG. 7 is a drawing highlighting features of the EATL technology with a planar speaker.

FIG. 8A illustrates a multi-way frequency divided IDC EATL system.

FIG. 8B is illustrates a cluster of DRE or IRE EATL enclosures to increase SPL in a single range.

FIG. 9 illustrates the use of the EATL technology with a horn coupling device.

FIG. 10 is a side cross-sectional view of the speaker system of FIG. 1 wherein the port has been replaced with a passive radiator mounted on the baffle board with the driver.

FIG. 11 illustrates a band-pass mode of operation of the system of FIG. 1 showing an acoustic low pass filter coupled to the front of the driver using a port to radiate the sound.

FIGS. 12A and 12B are a side cross-sectional view and a front view of a sound enhancement module.

FIG. 13 shows the sound enhancement module located in the coil diaphragm chamber.

FIG. 14 shows the ETL module 1402 positioned behind the pole piece.

FIG. 15 shows the ETL module attached to the pole piece

FIGS. 16 and 17 shows a speaker with two ETL modules.

FIG. 18 shows a microphone with an ETL module.

### DETAILED DESCRIPTION

Throughout this document there will be references to particular items, figures, names, phrases and notable words. The items will appear written once with a bold capital introductory letter and then abbreviated in the bold letters representing the name in text following. The capitalized bold first letter and abbreviation may appear subsequently to refresh the memory. Certain terms that may also have an importance in this document but are not pertaining directly to a feature of the document and will not be highlighted or underscored in this mode.

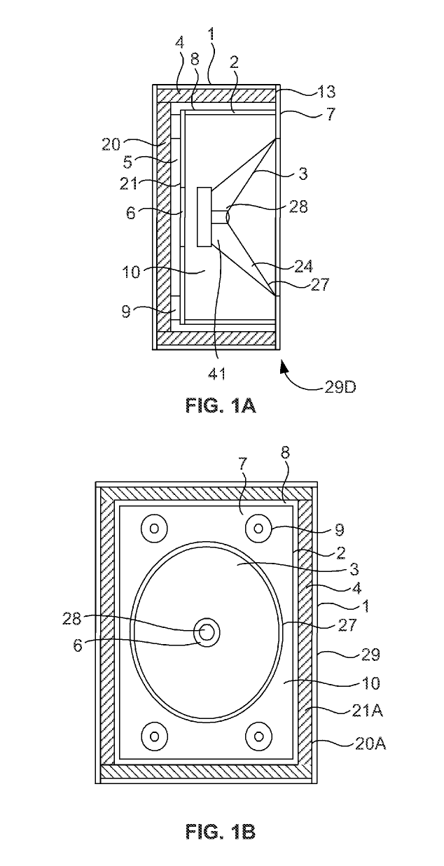

FIG. 1 represents an embodiment of the invention. FIG. 1A and FIG. 1B represent a complete Direct Radiator Enclosure (DRE) 29D speaker assembly constructed according to this invention. Bernoulli's theorem for the flow of liquid plainly states that a pressure differential must exist for a fluid to flow from a container through a discharge opening into a pressure region the same as that of the container. This means that if a sound (a fluid) of high quality is to be produced by a loudspeaker that a pressure differential must exists between its diaphragm and the atmospheric pressure and it must be consistent for all frequencies and acoustic conditions. All drivers of concern with this invention are bi-directional meaning that they radiate sound from both sides of the diaphragm. One side of the Driver Diaphragm (DD) 3 must be dynamically isolated from the Atmospheric Pressure at all frequencies within its range without concern for reflections from within or external. Dynamic isolation refers to isolation from atmospheric pressure when in motion not static isolation.

FIG. 1A illustrates a side cross sectional view of the DRE 29 enclosure with the Indirect coupled (IDC) Embedded Acoustic Transmission Line (EATL 5) structured to receive air pressure through its throat/mouth 6 behind the driver 41 mounted on baffle board 7 but buffered by the air chamber 10 of FIG. 1A. The EATL 5 unlike conventional trans-mission lines has its throat and mouth at the same point through superposition. IDC means that the wave that enters the EATL5 does so through an air chamber 10 of some relative volume so its influence on the DD 3 will be indirect yet influential. The EATL5 is constructed of the wave-guide 20 of the outer cabinet 1 and the wave-guide 21 of the Inner enclosure 2 separated by spacers 9. The EATL5 can be extended by using the side cabinet walls wave-guide 21 that are inherent in construction of the inner box in conjunction with extensions of wave-guide 20. These extensions of the EATL5 are 20A and 21A and will allow the EATL5 to operate to a lower frequency than the 20 and 21 alone but are generally relative to driver 41 size.

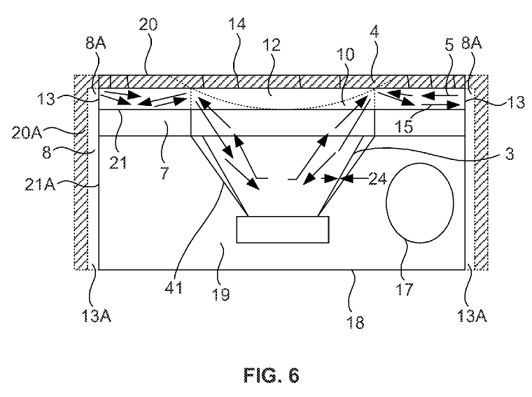

The EATL5 is sealed by the termination member 13 that contains the wave at one end of the EATL5 reverses it and creates Dynamic Standing Waves (DSW) at the throat/mouth 6 located in the center (from each corner) as seen in FIG. 1B. The term throat/mouth defining 6 results from the reflected wave having its point of exit at the same point as the waves point of entry. The fact that the in/out waves can be superimposed on each other accounts for this unique pressure feedback principle. The air volume within the EATL5 is always small relative to the operating volume of chamber 10 of FIG. 1 or 19 of FIG. 6 and is not a closed band-pass box. The overall dimensions may be further reduced using miniature construction techniques to enhance the output of smaller drivers in small spaces as well as OEM tweeter construction where the rear wave will be collected and returned as beneficial standing waves. The spacing dimensions can be reduced or increased as needed and the EATL5 may be repeatedly folded to increase its length as needed if 20A and 21A are not adequate in length.

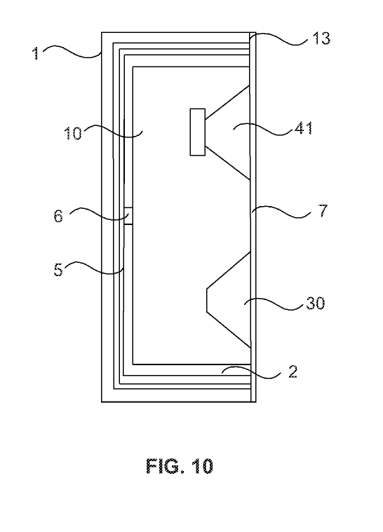

The EATL5 is lined with an Alternate Density Transmission Medium (ADTM4), which in the embodiment is open cell urethane foam that under normal air density and higher frequencies is inert, randomly accepting new air particles, yet at lower frequencies when pressurized allows additional air molecules to expand to within its cell structure in search of volume but instead are lost in heat dissipation. This is a lossy process hence the DSW and damping of the Driver Resonance Peak (DRP) as shown in FIG. 10A vs. FIG. 10B whereas FIG. 10A is the curve of the embodiment. Damping is a term referring to ability of a vibrating body to cease motion immediately when stimulus is removed.

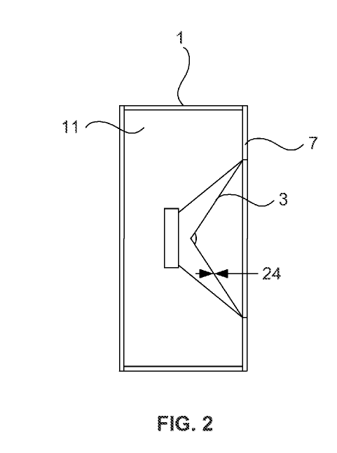

A relatively high frequency wave entering the throat/mouth 6 of the EATL5 has only to be within inches of the driver diaphragm 3 to reach its wavelength in normal air density. The enclosure in FIG. 2 is only a few inches deep meaning that any wave below 10 kHz would experience enclosure reflections almost immediately. FIG. 2 represents an enclosure of air volume 11 with identical dimensions as that of FIG. 1 but without 2 and 4 of that structure.

The waves traveling the stream lines 15 will enter the mouth 6 of the EATL5 and travel through the EATL5 barely interacting with the surface cells of the ADTM4 expanding almost immediately until it reaches the termination point 13, which then reflects the wave back toward the driver diaphragm 3. The throat/mouth 6 at the entrance of the EATL5 will experience nodes and anti-nodes (DSW), which overlap and influence the pressure in chamber 10 behind the driver 41 and are considered a positive pressure relative to the atmosphere.

As the frequencies go lower from that first influenced, the EATL5 will maintain a constant positive pressure on the driver diaphragm 3 due to the DSW condition of the air space 8 and the DSW condition caused by depth migration indicated by streamlines 14. As varying wavelengths/intensities occupy deeper depths of the ADTM4 cell structure they create individual DSW and therefore dynamically enhance motion of the driver diaphragm 3. The individual DSW produced will integrate their pressures and produce a composite DSW in the presence of multiple frequencies simultaneously (superposition).

Wave-guides 20, 21 must remain within a close spacing so as to contain the wave energy while directing it to the termination member 13. In the example, 20, 20A, 21, 21A are at 12 mm and 9 mm spacing respectively and will vary somewhat depending on driver diameter and purpose for system. The driver 41 will see these DSW influence its acoustic impedance because the pressure-differential with that of the atmosphere is maintained with frequency. The DSW are the result of changing frequencies, driver compliance and resistance by the ADTM4 material to the sound energy entering its cells.

The resulting interaction of the three variables maintains the chamber 10 pressure constant as the frequency changes while the drivers velocity remains linear. Internal pressure at chamber 10 would be a composite DSW resulting from the voice coil 28 signal input and the initial motion of the DD 3, the static pressure of 10 and the positive pressure created in the EATL5. This resultant composite pressure is constant and is relative to intensity and wavelength in the EATL5 and determines DD 3 motions.

A vibrating body will experience its greatest motion at resonance with less movement above and below that frequency for the same stimuli. The output (motion) falls much faster below resonance because of compliance while above it falls at a slower rate due to mass. The loss of output above resonance is directly related to mass (as it is affects the acceleration of the DD 3 as needed at higher frequencies) while the DSW in the EATL5 are directly related to frequency and increase pressure to counter the loss and maintain pressure constant (DD 3 in motion). The DSW generated internally at the mouth of the EATL5 provides positive pressure in real time buffered through volume of chamber 10 as each frequency may require in a composite wave maintaining maximum signal transfer relative to atmospheric pressure. The random standing waves existing in the enclosure of FIG. 2 disturb the dispersion pattern by producing random pressures on various parts of the DD3 to generate noisy sound.

It is difficult to determine parameters for certain products since the effects of field usage are hard to predict. Specifications developed to predict the vibration characteristics and dispersion of any given driver diameter are not useful if the enclosures SW are allowed to affect the DD 3 radiation pattern. This is one of the main reasons that engineers seek various types of suspension 27 and DD 3 materials as a solution to resist DD 3 breakup caused by these unknown sources. These breakup patterns are caused by random standing waves, which are dynamic and linked to the enclosure 1, amplifying source and signal. Random standing waves must be transformed into beneficial ones not resisted as in existing enclosure design if a neutral expression of a driver is to be observed. The elimination of random internal standing waves and the production of useful coherent ones allow the driver 41 to operate as specifications describe for the materials, diameter and construction.

A further result of this acoustically derived internal positive pressure is to further reduce diaphragm breakup as the pressure is applied to the entire surface to reduce the effects of solid transfer breakup modes. These are breakup modes that are generated when the voice coil 28 is stimulated.

Initial stimulation at 28 results in DD3 motions, flexing of all materials and a physical transfer of acoustical-mechanical energy towards the edges of the DD 3 as waves. At the outer edges of the DD 3 exist some type of flexible material 27 that surrounds and anchors the diaphragm to allow general motion of the entire moving assembly when the voice coil 28 stimulates it.

It is desired to have the energy that travels these paths dissipate in the diaphragm material and as kinetic energy into the surround material 27 and that does occur in most cases. The diaphragm and surrounding material 27 do not absorb all frequencies and some are reflected back toward the center or point of origin. In doing so waves, coherent and non-coherent, physically collide in the DD 3 material causing regions of positive and negative standing waves to exist on the DD3 surface that alter the dispersion pattern. These types of patterns can be observed and countered during engineering design phases and perhaps will result in a better driver 41. The EATL5 will minimize audibility of these types of breakup modes but not eliminate them.

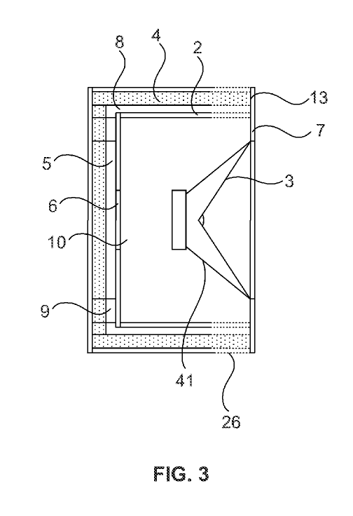

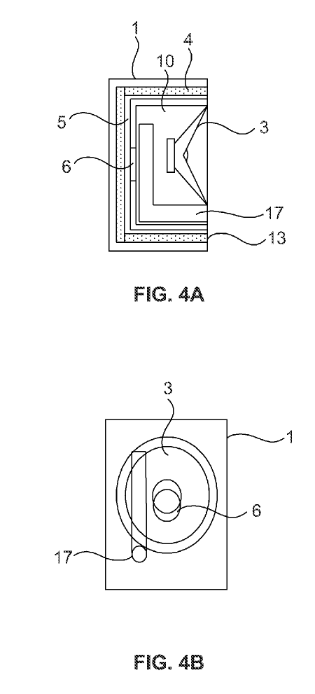

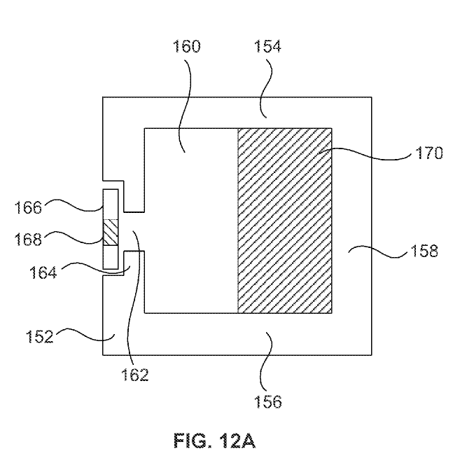

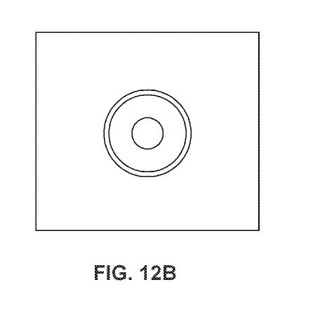

FIG. 4 represents the enclosure of FIG. 1 or FIG. 3 with the inclusion of a port 17 to enhance bass frequencies. The addition of a port 17 does not affect the DSW at the throat/mouth 6 and the maintenance of acceleration of higher frequencies by the EATL5 whose primary purpose in this embodiment is to counter the mass that results in signal loss above the resonance frequency of the driver 41. The EATL5 provides critical damping for the DD3 to improve stability at lower frequencies as indicated in FIG. 12B of FIG. 1 and FIG. 12D of FIG. 2. These impedance plots indicate that the resonance frequency remains near the same for both enclosures however the peak A of FIG. 12B indicates proper damping of the DD3 (as a controlled peak ratio is achieved for a smooth extended bass response and character) whereas the impedance plot of FIG. 12D indicates that the driver 41 has a high sharp resonance peak C (to indicate a sharp loose resonate sound).

This highly damped condition is maintained in the device of FIGS. 4A and 4B with a port 17 included to extend the response of bass.

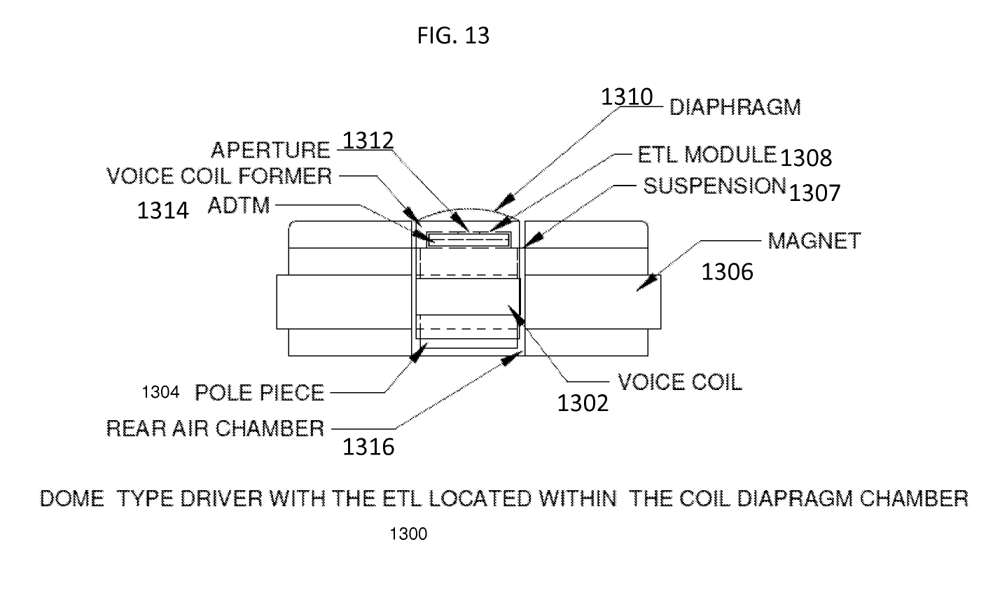

Shown in FIG. 10 is a simple illustration using a suitable passive radiator 30 substituted for the port to work in conjunction with the driver 41 to extended the bass to lower frequencies. The use of a passive radiator 30 would maintain the sealed condition of the acoustic system however all configurations would not benefit from this type of resonate system. Passive radiators 30 generally require more mounting area and would be suitable for larger systems with more available baffle board 7 area. The passive radiator 30 EATL5 configuration would maintain the same general characteristics as the ported system if it is aligned properly and have a curve similar to that of FIG. 13B.

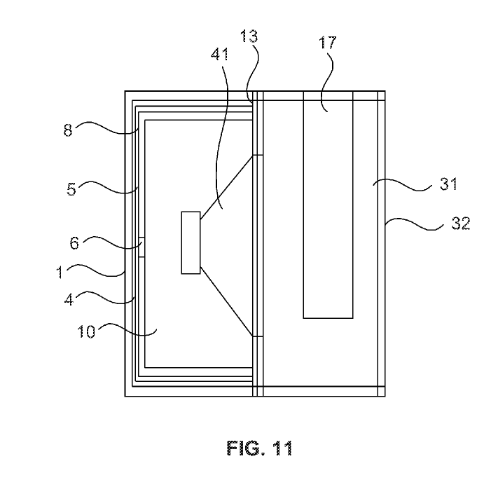

Another alignment for the DRE29I is that of coupling the front of the driver 41 to an acoustic low pass filter as in FIG. 11. A port 17 or passive radiator 30 is capable of acting as an acoustic low pass filter in conjunction with air mass 31. Here the EATL5 provides for constant pressure loading, damping and enhanced upper bass output and control while the port 17 establishes box loading with air volume 31 reducing DD 3 excursion allowing for a sealed air chamber 10 and better damping. The design will have three impedance peaks as that of the other ported EATL 5 designs one ahead and behind the DRF.

As in the earlier example, a passive radiator 30 can exist to resonate the new air mass 31 existing in front of the driver 41 when mounted in at least one wall of the additional enclosure 32. The IDC EATL5 acts as an ideal impedance matching device for virtually any conventional type of driver and loading method. It creates two ranges of increased pressure to benefit the frequencies above and below a drivers' resonance. Frequencies above resonance can be directly radiated as for the full range or the DD3 can be loaded into an acoustic low pass filter to focus on a range of bass frequencies.

A driver will have an optimum frequency range of operation that it is most suited to reproduce. It would be very difficult if not impossible to obtain perfect operation for one driver 41 over the range of 20 Hz to 20,000 Hz especially at higher power levels. Individual EATL5 optimized enclosures DRE 29 can focus their advantages on narrow sound ranges to assist the driver in its optimal range.

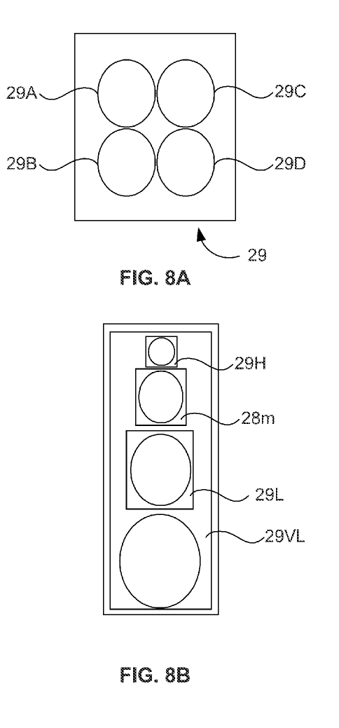

This may be for the purpose of dividing the sound ranges to use optimal drivers for each range FIG. 8B 29H, 29M, 29L, 29VL using individually optimized EATL5 enclosures or it may be for the purpose of increasing the sound level in a single range FIG. 8A 29A, 29B, 29C, 29D using multiple EATL5 enclosures operating in the same frequency range or for both applications simultaneously. This type of operation is enhanced because of the positive pressure behind each driver and the resistance therefore from interfering with other diaphragms.

Conventional close spacing of drivers' results in many unpredictable effects because the random nature of the individual internal standing waves further alters the dispersion pattern. The coherent output of EATL 5 enclosures will combine in multi-way speakers to make the crossover from one driver to another smoother and more lobe free. The coherent output from grouped reinforcement drivers whether cluster or line will perform according to their intended theory. A special housing 16 can be used to adjust the DRE 29 units properly for the application.

The EATL5 can also be used in conjunction with exotic acoustic transducers (drivers) such as with electrostatic and dynamic planar type diaphragms. Typically the flat panel loudspeakers radiate bi-directionally because of the negative effect an enclosure or close wall placement has to one side of the sensitive diaphragm. The random reflected standing waves are of even greater harm because of the large diaphragm surface area required to generate meaningful sound levels with these types.

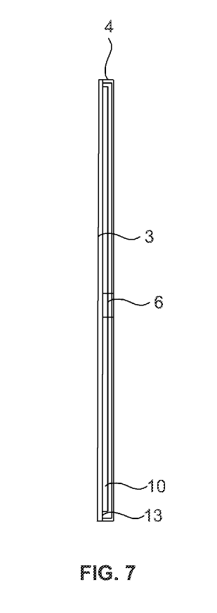

FIG. 7 is a simple illustration indicating the important reference parts for EATL5 use with these flat panel type loudspeakers. The EATL5 would consist of the same basic parts as illustrated as the dynamic driver 41 version only larger panels would be involved and adjustments of certain other parameters involved with EATL5 construction. Certain types of exotic drivers qualify and can only benefit from IDC of the EATL5 and this is the case for the planar speaker DD3.

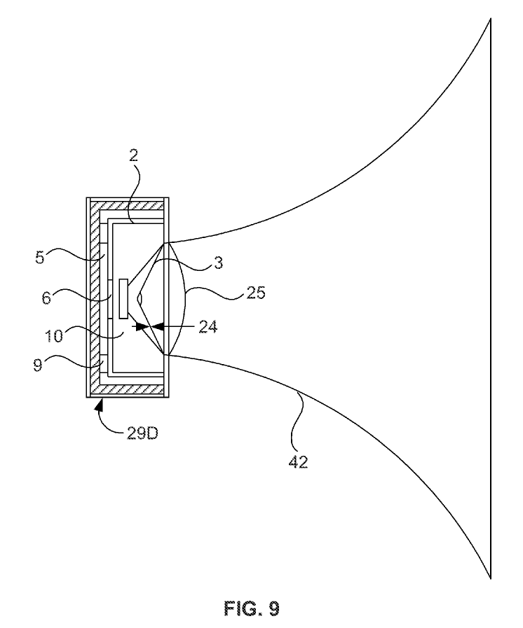

Illustrated in FIG. 9 is the use of a horn apparatus to IDC the EATL5 for further transmission benefit. Horns are generally used to increase the level, distance and some times coverage in a specific area while shadowing others. The close coupling of the horn extension to the unaided DD 3 of the horn produces intense reflections back into the DD 3. Typically a horn coupled driver 41 suffers chronically from breakup because these reflected features are acoustically amplified so the DD 3 suffers from competing horn bell type reflections at its surface.

A phase plug 25 may be necessary to maximize pressure transfer depending on the diaphragm type. The driver 41 operating with the positive pressure of the EATL5 assisted environment will not be as affected by these reflections producing a much clearer output from a well designed horn coupling.

Conventional loudspeakers need large diaphragm areas and/or high mass to produce low frequencies while attaining high efficiency in the process. The current processes for bass reproduction are inherently efficient because they operate the driver at and near its resonant frequency but this is also the Achilles' heel for sound quality. Resonance is the number one enemy of a finished sound system although the parameter is involved with the execution of any speaker system. The DC EATL 5 mode of operation will allow a very small driver to produce low bass frequencies at low to moderate efficiencies. When a 3″ driver is made capable of producing very low frequencies at a useful level then efficiency isn't a proper term to characterize its performance.

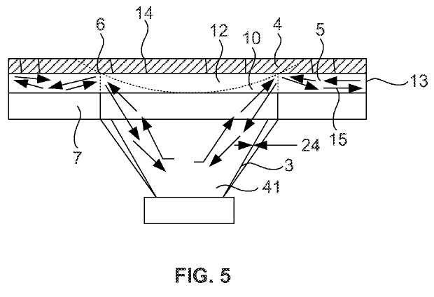

FIG. 5 represents the application of the EATL5 in conjunction with a dynamic driver 41 for the purpose of generating very low frequencies only and is called the Direct Coupled DC EATL 5. The EATL construction is very similar to the IDC with the exception of a larger throat/mouth opening 6 equal to the driver diameter and compression plug 12 located immediately in front of the driver 41. The EATL 5 is Directly Coupled (DC) to the driver 41 with minimum area air volume in chamber 10 between the driver and the throat/mouth 6 of the EATL 5. The driver is mounted with front facing the EATL5 mouth 6 so as to create a high compression chamber 10 for driver loading. In this mode the driver 41 is compression loaded so a compression plug 12 is used to help direct wave motion into the EATL 5 and to minimize air turbulence at the throat/mouth 6 of the EATL5 and to establish the correct throat/mouth 6 area for the EATL5.

DC coupling places the driver 41 completely under the influence of the EATL5 and it will follow the frequency pattern it establishes. The ADTM 4 establishes delay of the waves through depth migration thus allowing a wide DSW bandwidth. The higher low frequencies above driver 41 resonance are not effected as readily by the cellular structure and will sustain constant pressure in the EATL 5 before depth migration.

A reflex enclosure would further reduce DD 3 motion in the power bass frequency range (30 Hz-60 Hz) and not have a subsonic distortion problem after the EATL 5 peak. An acoustic low pass filter 18 connected to the driver 41/EATL 5 in FIG. 5 would favor the lowest frequencies.

The DCEATL 5 low frequency system develops output from diaphragm area not geometry. The listening room, typically being an acoustic space with dimensional gain, also favors lower frequencies if they are present.

Horn loading of the driver for low frequency reproduction while in the DC compression mode of operation can be effective if physical space isn't a real consideration. The well-loaded driver 41 is a good candidate for horn coupling to the ambient but large surface expansion areas are required to support launching of the long waves. In some cases embedded applications in buildings or large structures will allow portions of the structure to act as horn wave-guides. In some cases folding of the required waveguides will allow implementation of a low frequency horn even an enclosure version.

With the EATL 5 DRE 29D enclosures multiple units of the IRE 29I may be configured to increase the output as a combined coherent source as in FIG. 8A the sound will more approach the theoretical 6 db per doubling of units. This and the excellent immunity to the rooms' reflections will maintain the integrity of the source. The IRE 29I may also be combined as in FIG. 8B to have the EATL 5 peak to occur in different ranges to maximize the output in each range. This will allow for maximum low frequency output over a wider range.

Referring to FIGS. 12A and 12B, a sound enhancement module (also referred to as ETL in previous embodiments) includes a set of front 152, top 154, bottom 156, rear 158 side (not shown) walls that defines an enclosed chamber 160. The front wall has a circular aperture 162 surrounded by a recessed shelf or ledge 164. A circular disc 166 with a central opening 168 is positioned in the shelf.

Closed cell foam 170 or another type of alternative density medium (referred to as an ADTM) is positioned in the enclosed chamber 160. The section of closed cell foam 170 may be large enough to fill the entire space of the enclosed chamber 160. In another embodiment, the closed cell foam 170 is adhered to the rear wall 158 and takes up only a portion of the space of the enclosed chamber 160.

The sound enhancement module can be added to many different types of sound-producing devices to improve the sound quality of the device. For example, the module may be added to audio speakers that are installed in separate cabinets or in video displays. The module can also be added to the inside or outside of headphones. The sound enhancement module may also be used to retrofit existing speaker systems that are held in stock or are present at customer locations.

In other embodiments as shown in FIGS. 13-16, the sound enhancement module is built in to the speaker's driver. Referring to FIG. 13, the sound enhancement module is located in the coil diaphragm chamber of a dome type driver 1300. The driver includes a voice coil 1302 wound around a pole piece 1304 and a magnet 1306 and a suspension 1307 that allows motion. The ETL or sound enhancement module 1308 is attached to the front of the magnet 1306 immediately behind the speaker diaphragm or dust cap 1310. The module is enclosed by walls and an aperture 1312 that allows sound waves to enter the internal volume of the module where an alternative where a compressible ADTM 1314 is located. The driver may also include a rear air chamber 1316.

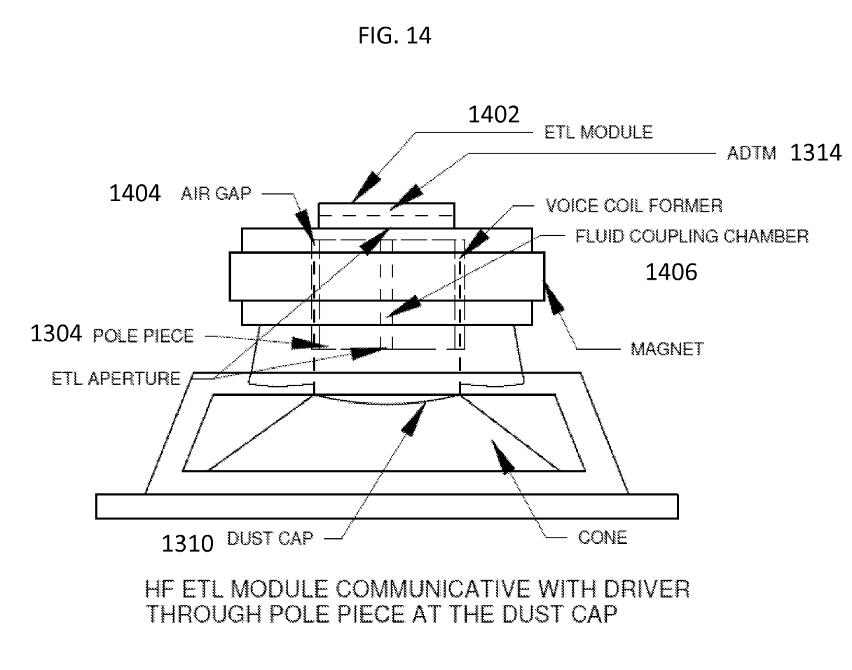

Referring to FIG. 14, the ETL module 1402 is positioned behind the pole piece 1304 at the end of the pole piece 1304 opposing the dust cap 1310. Sufficient air gaps 1404 and/or a fluid coupling chamber 1406 allow sound to travel from behind the dust cap 1310 to the module 1402.

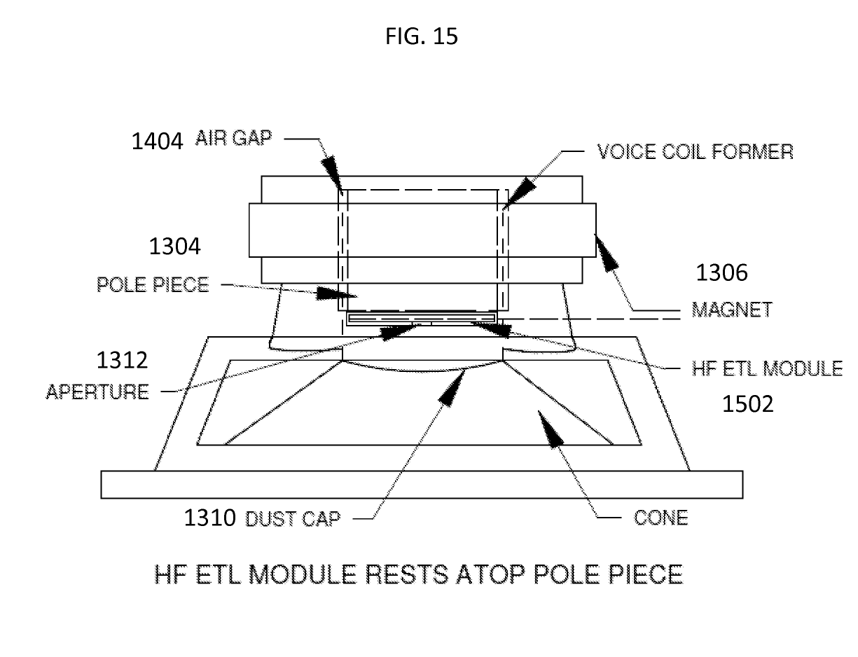

In another embodiment as shown in FIG. 15, the ETL module 1502 attaches to the pole piece 1304 immediately behind the dust cap 1310.

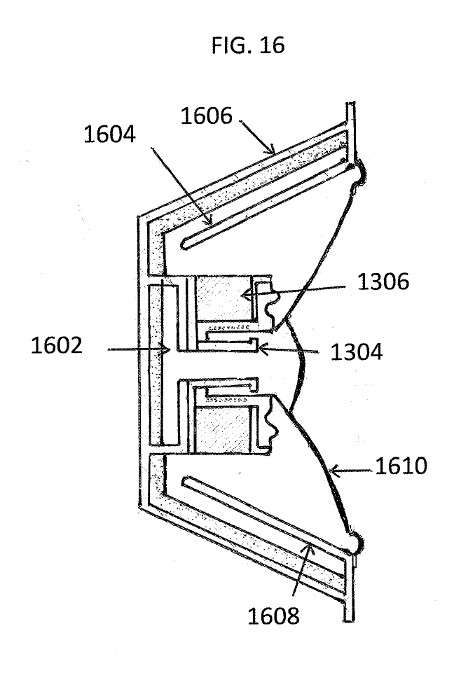

The ETL module may be built into the speaker in other configurations, such as, for example, more than one ETL module can be built into a speaker. As shown in FIG. 16, two ETL modules 1602, 1604 are built into the speaker. Referring to FIG. 16, a first ETL module is positioned behind the pole piece. The first ETL module 1602 is positioned behind the pole piece 1304 and the magnet 1306. The second ETL module 1604 is built in between the speaker frame 1606 and an inner wall 1608 behind the speaker cone 1610.

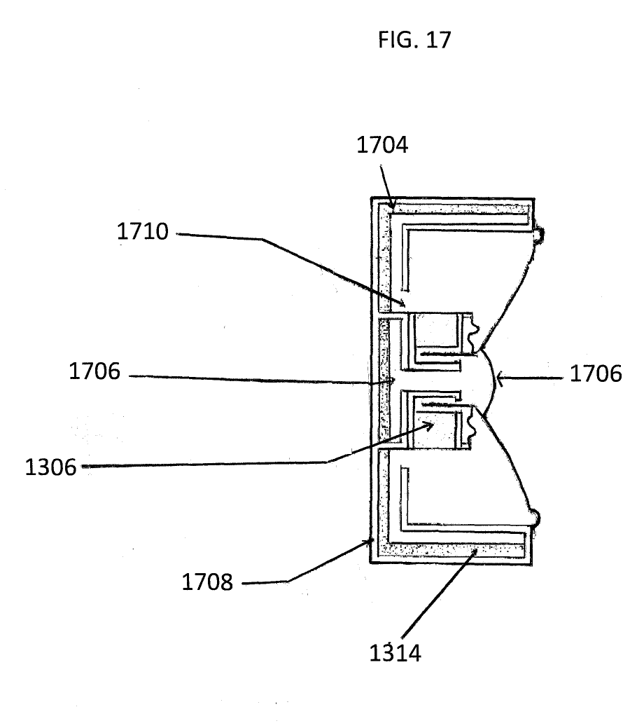

Referring to FIG. 17, two ETL modules 1702, 1704 are also employed. The first ETL module 1702 is configured immediately behind a vented pole piece 1706 with the magnet 1306 bonded directly to the ETL module 1702. The second ETL module 1704 is built into a molded enclosure 1708 that replaces a conventional speaker frame. The second ETL module 1704 has a ring aperture 1710 that encircles the magnet 1306.

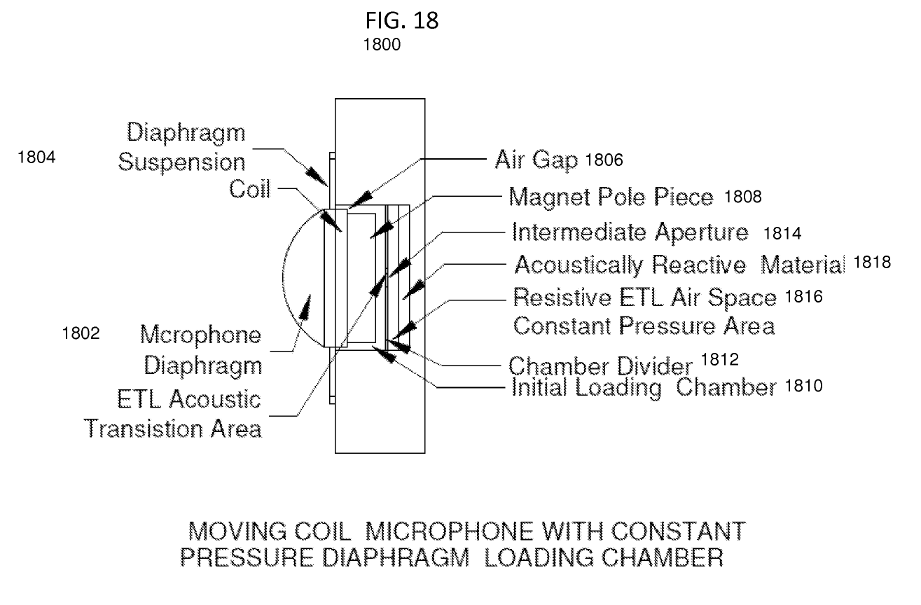

In another embodiment shown in FIG. 18, the ETL module is enclosed in a microphone 1800. The microphone includes a diaphragm 1802 and a diaphragm suspension coil 1804. An air gap 1806 and a magnet pole piece 1808 are positioned behind the diaphragm 1802.

As initial loading chamber 1810 is separated by a chamber divider 1812, which leads to an intermediate aperture 1814 The intermediate aperture 1814 provides an opening into a chamber referred to as an ETL air space 1816. An acoustically reactive material 1818, such as, for example, compressible foam, is positioned in the ETL air space 1816.

Changes may be made in the above apparatus without departing from the scope of the invention herein involved. Thus, all matter in the above description or shown in the accompanying drawing are illustrative and not limited to the specific embodiments. Accordingly, other implementations are within the scope of the following claims.

I claim:

1. A speaker, comprising:
a magnet;
a pole piece positioned within the magnet;
a sleeve surrounding the pole piece;
a conductive wire coil wound around the sleeve between the magnet and the pole piece;
a dust cap or diaphragm attached to a circumference of the sleeve;
a speaker cone surrounding the dust cap; and
an enclosed chamber having an aperture to access an internal volume of the chamber and an alternative density transmission medium (ADTM) positioned within a portion of the internal volume.

2. The speaker of claim 1, wherein the chamber is positioned at a first end of the pole piece proximate to the dust cap.

3. The speaker of claim 1, wherein the chamber is positioned at a second end of the pole piece distal to the dust cap.

4. The speaker of claim 3, wherein an air passage is configured to connect the internal volume of the chamber to the volume behind the dust cap.

5. The speaker of claim 4, wherein the air passage comprises a passageway through the pole piece.

6. The speaker of claim 1, wherein the pole piece comprises a cavity that defines the chamber.

7. The speaker of claim 1, wherein the magnet comprises a cavity that defines the chamber.

8. The speaker of claim 1, wherein the aperture comprises an opening in a surface of the magnet to define the aperture.

9. The speaker of claim 1, wherein the chamber comprises a first internal surface and the alternative density transmission medium is mounted to the first internal surface.

11. The speaker of claim 10, wherein a surface area (X) of the first internal surface comprises X=√A₁, wherein A₁ comprises the speaker cone area.

12. The speaker of claim 10, wherein a surface area (X) of the first internal surface includes a range from X=√0.7A₁ to X=√1.2A₁.

13. The speaker of claim 1, wherein the aperture size (Φ₀) comprises r₁/π, wherein r₁ comprises a speaker cone radius (r₁).

14. The speaker of claim 1, wherein: the chamber comprises a first internal surface and a second internal surface, the alternative density transmission medium is mounted to the first internal surface, and a distance between the first internal surface and the second internal surface includes the thickness (t) of the alternative density transmission and a length of an air gap (T).

15. The speaker of claim 14, wherein the thickness of the alternative density transmission medium comprises: t=√r₁, wherein r₁ comprises a speaker cone radius.

16. The speaker of claim 14, wherein the length of the air gap comprises: T=√Φ₁, wherein Φ₁ comprises a diameter of the speaker cone.

17. The speaker of claim 1, wherein the internal volume (V) of the chamber comprises: V=A₁, wherein Aₗ comprises the area of the speaker cone.

18. The speaker of claim 1, wherein the internal volume (V) of the chamber comprises a range from V=0.7A₁ to V=1.2A₁, wherein A₁ comprises the area of the speaker cone.

19. The speaker of claim 1, wherein the alternative density medium comprises a compressible foam material.

20. The speaker of claim 1, wherein the alternative density medium comprises a closed cell foam.

21. The speaker of claim 1, wherein the chamber is centered along a radial axis of the pole piece.
